(19) United States
(12) Patent Application Publication
(10) Pub. No.: US 2010/0031643 A1
(43) Pub. Date: Feb. 11, 2010

(54) AIR SYSTEM INCLUDING A VARIABLE GEOMETRY TURBOCHARGER FOR SUPPLYING AIR TO A REGENERATION SYSTEM

(75) Inventors: Glenn Brian Cox, Peoria, IL (US); David Joseph Kapparos, Chillicothe, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/189,425

(22) Filed: Aug. 11, 2008

(51) Int. Cl. F01N 3/023; F02B 33/40

(52) U.S. Cl. 60/295; 60/624

(57) ABSTRACT

A system for supplying air to a regeneration system associated with an engine is disclosed. The system may include an engine including an intake manifold and an exhaust manifold. The system may also include a variable geometry turbocharger including a turbine and a compressor, the turbine in fluid communication with the exhaust manifold and the compressor in fluid communication with the intake manifold. A regeneration system may be associated with the engine, the regeneration system including a fuel injector and an air inlet, the compressor in fluid communication with the air inlet of the regeneration system.

### TECHNICAL FIELD

The present disclosure relates to an air system, and, more particularly, to an air system including a variable geometry turbocharger for supplying air to regeneration system.

### BACKGROUND

Modern diesel engines often include subsystems designed to increase performance. One example of a performance enhancing engine subsystem includes a particulate trap and associated regeneration device. Diesel engines exhaust a complex mixture of air pollutants composed of solid particulate material in the form of unburned carbon particles. In order to meet stringent emissions standards, engine manufacturers have developed devices for treatment of engine exhaust after the exhaust leaves the engine. One such exhaust treatment device is the particulate trap, which includes a filter designed to collect particulate matter from the exhaust flow of an engine. The use of the particulate trap for extended periods of time, however, enables particulate matter to accumulate on the filter, thereby causing damage to the filter and/or a decline in engine performance. One method of restoring the performance of a particulate trap includes regeneration. Regeneration of a particulate trap filter is accomplished by increasing the temperature of the filter and the trapped particulate matter above the combustion temperature of the particulate matter, thereby burning away the collected particulate matter. This increase in temperature may be accomplished by heating the exhaust gases upstream from the particulate trap with the use of a burner that creates a flame within the exhaust conduit leading to the particulate trap. The burner may include a fuel injector for creating the flame, and the burner may be supplied with air from the intake system of the engine.

One example of a system that provides air from an intake system of an engine to a particulate trap associated with the engine is shown in United States Patent Application Publication No. 2007/0283697 (the '697 publication). The '697 publication discloses a variable geometry turbocharger with a compressor and a turbine. Compressed air is drawn from the compressor via a recirculation passageway and directed to an inlet of a particulate filter downstream of the turbine.

While the '697 publication provides a mechanism to provide air to a particulate filter for regeneration-purposes, nowhere does the '697 publication disclose a control strategy for providing an appropriate boost air pressure from the compressor to allow regeneration. Moreover, nowhere does the '697 publication disclose providing the compressed air to a regeneration system utilizing a burner configuration. Furthermore, the '697 publication teaches away from taking the compressed air from a location downstream of the compressor between the compressor and the intake manifold because, according to the '697 publication, engine performance may be compromised. Instead, the '697 publication encourages taking the compressed air from the compressor via the recirculation passageway provided between the compressor outlet and the compressor inlet.

The disclosed air system is directed to improvements in the existing technology.

### SUMMARY

In one aspect, the present disclosure is directed toward a system for supplying air to a regeneration system associated with an engine, the system including an engine including an intake manifold and an exhaust manifold; a variable geometry turbocharger including a turbine and a compressor, the turbine in fluid communication with the exhaust manifold and the compressor in fluid communication with the intake manifold; and a regeneration system associated with the engine, the regeneration system including a fuel injector and an air inlet, the compressor in fluid communication with the air inlet of the regeneration system.

In another aspect, the present disclosure is directed toward a system for supplying air to a regeneration system associated with an engine, the system including an engine including an intake manifold and an exhaust manifold; a variable geometry turbocharger including a turbine and a compressor, the turbine in fluid communication with the exhaust manifold and the compressor in fluid communication with the intake manifold; and a regeneration system associated with the engine, the regeneration system including an air inlet, the compressor in fluid communication with the air inlet of the regeneration system, the air inlet disposed between the compressor and the intake manifold and configured to provide air to the regeneration system.

In yet another aspect, the present disclosure is directed toward a method for supplying air to regeneration system, the method including the steps of compressing air with a variable geometry turbocharger; directing the compressed air towards an intake manifold of an engine; and supplying at least a portion of the compressed air to an air inlet of a regeneration system associated with the engine, the air inlet disposed between a compressor of the variable geometry turbocharger and the intake manifold of the engine.

### BRIEF DESCRIPTION OF THE DRAWINGS

FIG. 1 is a schematic view of an engine, an air system including a turbocharger, and a regeneration system according to an exemplary embodiment of the present disclosure;

FIG. 2 is a cross-sectional view of a portion of the turbocharger of FIG. 1; and

FIG. 3 is another cross-sectional view of a portion of the turbocharger of FIG. 1.

### DETAILED DESCRIPTION

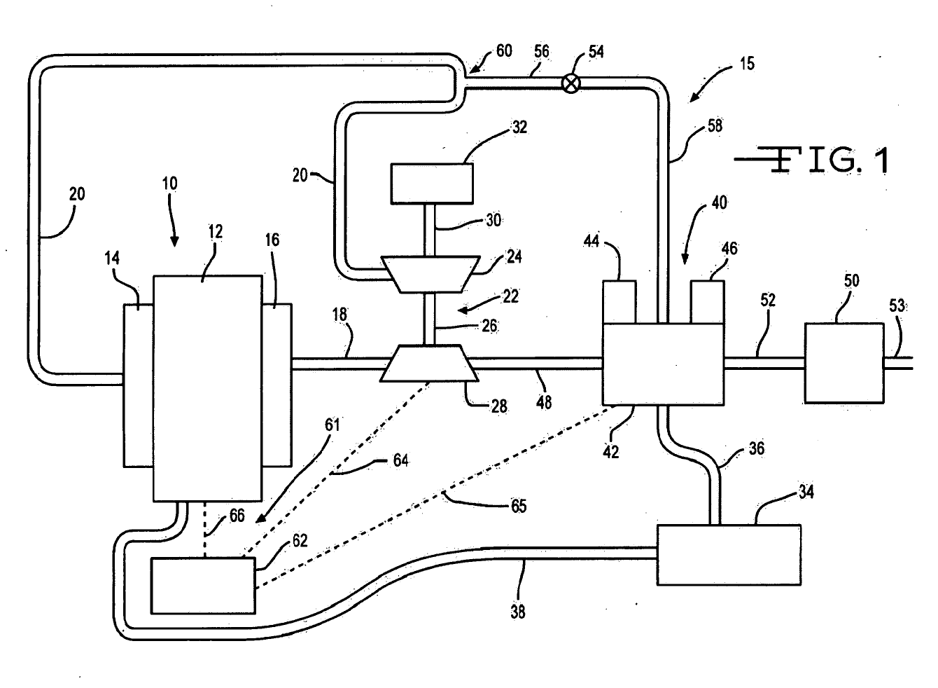

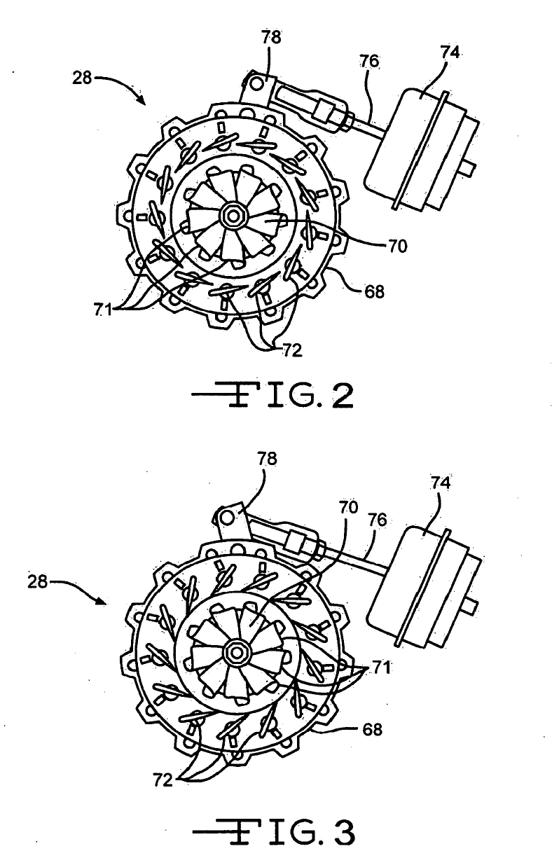

Throughout the specification and figures, like reference numerals refer to like components or parts. Referring how to FIG. 1, an air system 15 for providing air to an engine and a regeneration system is shown and may include a variable geometry turbocharger 22. The variable geometry turbocharger (VGT) 22 includes a turbine 28, a compressor 24, and a shaft 26 that connects the turbine 28 and the compressor 24. The turbine 28 receives exhaust gases from a plurality of combustion chambers within cylinders (not shown) of an engine block 12 of an internal combustion engine 10 via an exhaust manifold 16 and an exhaust conduit 18. Upon entering the turbine 28, the exhaust gases are directed through circumferentially disposed nozzle vanes 72 (FIGS. 2 and 3) onto the blades of a rotary turbine wheel 70 (FIGS. 2 and 3). The exhaust gases are then discharged from the turbine 28 into an exhaust conduit 48. In one embodiment, more than one turbine 28 may be included and disposed in parallel or in series relationship. Turbochargers are conventionally used in internal combustion engines to increase the amount of injected intake air so as to increase the output of the engine. In particular, variable geometry components in the turbine and/or the compressor may include variable nozzle vanes ahead of the turbine wheel and/or variable diffuser vanes in the compressor component, respectively. Variable nozzle vanes ahead of the turbine wheel are connected together so that the throat area of each nozzle passage can be selectively reduced or increased corresponding to a desired operating condition, as described below.

The turbine wheel 70 (FIGS. 2 and 3) rotatably drives a compressor wheel (not shown) in the compressor 24 via shaft 26. The compressor 24 receives ambient air from an ambient air intake conduit 30 after the ambient air is filtered via an air filter 32. The driven compressor wheel is adapted to compress and discharge air at greater than atmospheric pressure into an intake air conduit 20. In one embodiment, more than one compressor 24 may be included and disposed in parallel or in series relationship. Fuel is provided to engine 10 via a fuel conduit 38 connected to a fuel supply 34 and is injected into the engine cylinders via at least one fuel injector (not shown). Air is provided to an intake manifold 14 of engine 10 via the intake air conduit 20 to be directed into the engine cylinders to facilitate combustion of the injected fuel within the combustion chambers.

Referring still to FIG. 1, a regeneration system 40 may be positioned anywhere along an exhaust conduit between the engine 10 and an after-treatment component 50 to directly raise the temperature of the exhaust gases exiting the engine 10. As shown in FIG. 1, the regeneration system 40 is provided via an exhaust conduit 48 with exhaust gases that have exiled engine 10 and have been routed through the turbine 28. Alternatively, the exhaust conduit 48 may extend directly from exhaust manifold 16 to the regeneration system 40 such that at least a portion of the exhaust gases bypasses the turbine 28. Regeneration system 40 may include a fuel injector 44 configured to inject fuel into the exhaust gases, an intake air inlet 60 configured to provide compressed air into the exhaust gases and mix with the injected fuel, and an ignition device 46 configured to ignite the fuel/pressurized air mixture. The fuel injector 44 may be any suitable fuel injector known in the art, such as a common rail fuel injector, a mechanically actuated electronic fuel injector, or a hydraulically actuated electronic fuel injector. The ignition device 46 may include a sparking device such as a spark plug, a heater, a glow plug, or any other mechanism for igniting the air/fuel mixture. Fuel may be supplied to the fuel injector 44 via a fuel conduit 36 connected to the fuel supply 34. Air may be supplied to the regeneration system 40 via an intake air conduit 56 extending from the intake air inlet 60, a control valve 54, and an intake air conduit 58 extending from the control valve 54 and connected to a regeneration device 42 of the regeneration system 40. The control valve 54 may be an on/off valve or an incremental valve to permit only a desired amount of compressed intake air through conduit 58. In an exemplary embodiment, the control valve 54 may be a butterfly valve, a poppet valve, or any other type of controllable valve. Regeneration system 40 may create a flame upon ignition of the fuel/air mixture, which may be in a heat exchange relationship with the exhaust gases flowing through the regeneration device 42. Current may be supplied to the ignition device 46 to ignite the air/fuel mixture before or after the mixture is delivered into the exhaust gases.

The flame provided by the regeneration system 40 raises the temperature of the exhaust gases as the gases exit the regeneration system 40 via an exhaust conduit 52. The heated exhaust gases travel to the after-treatment component 50, which is capable of removing various exhaust gas components, such as a complex mixture of air pollutants composed of solid particulate material in the form of unburned carbon particles, prior to the exhaust gases exiting to the atmosphere via an exhaust outlet 53. In an exemplary embodiment, the after-treatment component 50 is formed as a diesel particulate filter (DPF).

A controller 62 may be in communication with various components of the system illustrated in FIG. 1 including the engine 10 via a communication line 66, the VGT 22 via a communication line 64, and the regeneration system 40 via a communication line 65. The controller 62 may also be in communication with the control valve 54 via any one of communication lines 66, 64, 65, depending on the configuration of the system. The operation of the controller 62 is described further below.

Referring now to FIGS. 2 and 3, the turbine 28 of the VGT 22 includes a turbine housing 68 which houses a plurality of turbine vanes 72 and the turbine wheel 70. The radial angle of the vanes 72 determines the angle of entry at which the exhaust gases flow into the blades 71 of the turbine wheel 70. As the vanes 72 move, a flow area between the vanes 72 may change, thereby changing the aspect ratio and performance of VGT 22. The angle of the vanes 72 may be varied from fully open to fully closed positions to vary the speed of the turbine wheel 70. For example, as the vanes 72 progressively open, the angle of entry of the exhaust gases becomes progressively lower, thereby decreasing both a speed of the turbine wheel 70 and an exhaust gas backpressure. The vanes 72 are shown towards the fully closed position in FIG. 2 and the vanes 72 are shown towards the fully opened position in FIG. 3. When the vanes 72 are in the substantially open position shown in FIG. 3, substantially no boost air pressure is provided by VGT 22 because the speed of the turbine wheel 70 is substantially lower as compared to when the vanes 72 are substantially closed. When the vanes 72 are in the substantially closed position shown in FIG. 2, the size of the flow area for the exhaust gases to reach the turbine wheel 70 is decreased, thereby accelerating the exhaust gases towards the turbine wheel 70. Moreover, the exhaust gases hit the blades 71 of the turbine wheel 70 at approximately a right angle. Both of these conditions cause the turbine wheel 70 to rotate faster. Consequently, VGT 22 provides boost air pressure because the turbine wheel 70 rotates relatively faster as compared to the state of FIG. 3 and thereby compresses the intake air entering the compressor 24 (FIG. 1) in excess of atmospheric pressure. Furthermore, as the flow area decreases, the pressure within the exhaust conduit 18 upstream of turbine 28 may proportionally increase. This increased backpressure may cause the turbine wheel 70, shaft 26, and connected compressor 24 to rotate at a faster rate, thereby resulting in an increased boost air pressure because more air is being compressed via compressor 24. In contrast, as the flow area increases, the pressure within the exhaust conduit 18 may proportionally decrease, and turbine wheel 70, shaft 26, and compressor 24 may slow down, thereby compressing less air.

In an exemplary embodiment, the turbine 28 may include an actuator 74. The vanes 72 are movable by the actuator 74. The actuator 74 may include a plunger 76, which may be hydraulically, pneumatically, or mechanically actuated, that is connected to a lever 78. Upon extension of the plunger 76, the lever 78 pivots counterclockwise as shown in the transition from FIG. 2 to FIG. 3. The counterclockwise (as viewed in FIGS. 2 and 3) pivoting movement of the lever 78 causes the vanes 72 to open. In contrast, upon retraction of the plunger 76, the lever 78 pivots clockwise as shown in the transition from FIG. 3 to FIG. 2. The clockwise (as viewed in FIGS. 2 and 3) pivoting movement of the lever 78 causes the vanes 72 to close. The actuator 74 may be controlled by the controller 62 via communication line 64, as described below.

In an alternative embodiment, the turbine 28 may have a nozzle ring adjustable by actuator 74. During operation of VGT 22, the orientation of the nozzle ring may be adjusted to vary a flow area through a nozzle portion (not shown) of turbine 28. It is contemplated that other types of VGTs may also be utilized in conjunction with the disclosed system.

A control system 61 may be associated with the system 15 to regulate the operation of VGT 22 during a regeneration mode of operation. In particular, the control system 61 may include the controller 62 in communication with actuator 74 by way of the communication line 64. In response to a regeneration mode of operation command, controller 62 may regulate actuator 74 to vary the flow area of turbine 28.

The command for regeneration may be received by way of an operator input device (not shown), which may be in communication with controller 62 via a communication line (not shown). For example, as an operator activates the input device, the command for regeneration is sent to the controller 62. It is contemplated that the command for regeneration may alternatively or additionally be automatically generated based on one or more operational parameters of engine 10 (e.g., a travel speed, a gear ratio, an incline, etc.), regeneration system 40, and/or after-treatment component 50.

Controller 62 may embody a single microprocessor or multiple microprocessors that include means for controlling an operation of engine 10, VGT 22, and regeneration system 40. Numerous commercially available microprocessors can perform the functions of controller 62. It should be appreciated that controller 62 could readily embody a general engine control unit (ECU) capable of controlling numerous functions associated with engine 10. Controller 62 may include all of the components required to run an application such as, for example, a memory, a secondary storage device, and a processor, such as a central processing unit or any other means known in the art for controlling engine 10, VGT 22, and/or regeneration system 40. Various other known circuits may be associated with controller 62, including power supply circuitry, signal-conditioning circuitry, solenoid driver circuitry, communication circuitry, and other appropriate circuitry. Controller 62 may analyze and compare received and stored data, and, based on instructions and data stored in memory or input by a user, determine whether action is required. For example, controller 62 may compare received values with target values stored in memory, and, based on the results of the comparison, controller 62 may transmit signals to one or more systems to alter the operating status thereof.

Controller 62 may include any memory device known in the art for storing data relating to operation of engine 10, VGT 22, and regeneration system 40. The data may be stored in the form of one or more maps that describe and/or relate operation of engine 10, VGT 22, and regeneration system 40. Each of these maps may be in the form of tables, graphs, and/or equations, and include a compilation of data collected from lab and/or field operation of engine 10, VGT 22, and regeneration system 40. The maps may be generated by performing instrumented tests on the operation of engine 10, VGT 22, and regeneration system 40 under a variety of operating conditions while varying parameters such as engine speed, air flow, and fuel delivery. Controller 62 may also be capable of updating the maps based on measured operating conditions, which may allow controller 62 to adjust the maps to match the particular operating characteristics and modes of an exemplary engine 10. Controller 62 may reference these maps and control the operation of one component in response to the desired operation of a second component. For example, controller 62 may reference the maps to control VGT 22 to maintain a desired operation of regeneration system 40. The maps may contain data on, for example, the time required for engine 10 to be active before controller 62 activates regeneration system 40, and other data that affects the operation of regeneration system 40 based on the operation of engine 10 and/or VGT 22.

Controller 62 may also include a timing device (not shown). Controller 62 may be configured to couple information from the timing device with information from other sources. For example, controller 62 may utilize information from the timing device in conjunction with information regarding operation of engine 10 to determine how long engine 10 is operated and/or from regeneration system 40 to determine how long and when regeneration system 40 is operated. The timing device may also be used to monitor and control duration of regeneration events or any other operating parameters of regeneration system 40, as well as any other operating parameters of engine 10.

Controller 62 may be configured to activate regeneration system 40 based on one or more inputs commonly known in the art and the maps stored in memory of controller 62. For example, controller 62 may monitor an engine speed sensor (not shown), a travel speed sensor (not shown), the operation of engine 10, and operator input received via the operator input device or interface, and, based on the data contained in the maps, determine that more boost air pressure for regeneration system 40 is necessary. Based on this determination, controller 62 may activate actuator 74 to manipulate, e.g., open or close, the vanes 72. Controller 62 may then monitor the operating status of regeneration system 40, engine 10, input from the engine speed sensor, the travel speed sensor, the operator interface, other measured engine parameters, and other sensors known in the art, to determine, for example, the duration of regeneration system 40 activation, whether VGT 22 should be adjusted to provide more or less compressed air to regeneration system 40, and/or whether regeneration system 40 should be deactivated.

Controller 62 may be configured to activate regeneration system 40 in response to one or more trigger conditions commonly known in the art. The trigger conditions may include, for example, operation of engine 10 for a predetermined amount of time, consumption of a predetermined amount of fuel by engine 10, detection of an elevated backpressure upstream of after-treatment component 50 above a predetermined pressure, detection of an excessive pressure differential across after-treatment component 50, and/or determination that a calculated amount of particulate matter accumulated in after-treatment component 50 is above a predetermined amount. Regeneration may also be initiated manually at the operator interface, such as via a switch, button, or the like associated with the operator interface, and/or a service tool configured to interface with controller 62 and/or regeneration system 40.

Although described throughout as having a single turbocharger 22, the present disclosure also contemplates an air system including more than one turbocharger. For example, a non-variable geometry turbocharger may be situated in the position of VGT 22 in FIG. 1 and then VGT 22 added downstream or upstream of the turbocharger to provide a mechanism to selectively provide more boost air pressure to the regeneration system 40 without affecting the operation of the main turbocharger.

### INDUSTRIAL APPLICABILITY

The disclosed air system may be applicable to any engine and/or machine utilizing a regeneration system for regenerating an after-treatment component.

In operation, the air system 15 selectively provides compressed air to the regeneration system 40 for purposes of operating the regeneration device 42, thereby raising the temperature of the exhaust gases exiting the regeneration system 40 via the exhaust conduit 52 prior to entering the after-treatment component 50. The controller 62 controls the position of the vanes 72 of the turbine 28 of the VGT 22. The position of the vanes 72 controls the amount of compressed air that is compressed by the compressor 24 of the VGT 22, thereby allowing a desired amount of compressed air to be delivered to the regeneration system 40 during a regeneration mode of operation.

The compressed air exits the compressor 24 via intake air conduit 20 and may be delivered to the intake manifold 14 of the engine 10 and the intake air inlet 60 of the regeneration system 40. The control valve 54 may be used to control whether intake air is supplied to the regeneration system 40. In an exemplary embodiment, the control valve 54 restricts the amount of air provided to the regeneration system 40 and boost compressed air is provided to the intake air inlet 60 via controlling the position of the vanes 12 and/or via control of the control valve 54. The intake air provided to the intake air inlet 60 is used to facilitate combustion within the regeneration device 42 to increase the temperature of the exhaust gases.

It will be apparent to those skilled in the art that various modifications and variations can be made to the disclosed air system without departing from the scope of the disclosure. Other embodiments of the air system will be apparent to those skilled in the art from consideration of the specification and practice of the air system disclosed herein. It is intended that the specification, illustrations, and examples be considered as exemplary only, with a true scope of the disclosure being indicated by the following claims and their equivalents.

What is claimed is:

1. A system for supplying air to a regeneration system associated with an engine, the system comprising:
an engine including an intake manifold and an exhaust manifold;
a variable geometry turbocharger including a turbine and a compressor, the turbine in fluid communication with the exhaust manifold and the compressor in fluid communication with the intake manifold; and
a regeneration system associated with the engine, the regeneration system including a fuel injector and an air inlet, the compressor in fluid communication with the air inlet of the regeneration system.

2. The system of claim 1, further including a control valve, the control valve configured to control flow of air from the compressor to the regeneration system.

3. The system of claim 1, wherein the turbine includes a plurality of vanes, the plurality of vanes configured to control an amount of exhaust gases admitted to a turbine wheel of the turbine.

4. The system of claim 1, further including an after-treatment component disposed downstream of the regeneration system.

5. The system of claim 4, wherein the after-treatment component includes a diesel particulate filter.

6. The system of claim 1, wherein the regeneration system further includes an ignition device.

7. A system for supplying air to a regeneration system associated with an engine, the system comprising:
an engine including an intake manifold and an exhaust manifold;
a variable geometry turbocharger including a turbine and a compressor, the turbine in fluid communication with the exhaust manifold and the compressor in fluid communication with the intake manifold; and
a regeneration system associated with the engine, the regeneration system including an air inlet, the compressor in fluid communication with the air inlet of the regeneration system, the air inlet disposed between the compressor and the intake manifold and configured to provide air to the regeneration system.

8. The system of claim 7, further including a control valve, the control valve configured to control flow of air from the compressor to the regeneration system.

9. The system of claim 7, wherein the turbine includes a plurality of vanes, the plurality of vanes configured to control an amount of exhaust gases admitted to a turbine wheel of the turbine.

10. The system of claim 7, further including an after-treatment component disposed downstream of the regeneration system.

11. The system of claim 10, wherein the after-treatment component includes a diesel particulate filter.

12. The system of claim 7, wherein the regeneration system further includes a fuel injector and an ignition device.

13. A method for supplying air to a regeneration system, the method comprising the steps of:
compressing air with a variable geometry turbocharger;
directing the compressed air towards an intake manifold of an engine; and
supplying at least a portion of the compressed air to an air inlet of a regeneration system associated with the engine, the air inlet disposed between a compressor of the variable geometry turbocharger and the intake manifold of the engine.

14. The method of claim 13, wherein the directing step precedes the supplying step.

15. The method of claim 13, wherein the supplying step occurs prior to the compressed air reaching the intake manifold of the engine.

16. The method of claim 13, wherein the compressing step includes the step of manipulating vanes of a turbine of the variable geometry turbocharger, wherein the manipulation of the vanes determines an amount of compressed air exiting the compressor of the variable geometry turbocharger.

17. The method of claim 13, wherein the supplying step includes the step of controlling a control valve associated with the air inlet of the regeneration system.

18. The method of claim 13, wherein the supplying step includes the step of manipulating vanes of a turbine of the variable geometry turbocharger, wherein the manipulation of the vanes determines an amount of compressed air exiting the compressor of the variable geometry turbocharger.
